(19) United States
(12) Patent Application Publication
(10) Pub. No.: US 2024/0191944 A1
(43) Pub. Date: Jun. 13, 2024

(54) LYOPHILIZER PLATES HAVING HIGH EMISSIVITY

(71) Applicant: Terumo BCT, Inc., Lakewood, CO (US)

(72) Inventors: Dennis J. Hlavinka, Arvada, CO (US); Frank Corbin, III, Lakewood, CO (US); Daniel Clement, Lakewood, CO (US)

(21) Appl. No.: 18/526,125

(22) Filed: Dec. 1, 2023

Related U.S. Application Data
(60) Provisional application No. 63/431,134, filed on Dec. 8, 2022.

(51) Int. Cl. F26B 5/06; F26B 25/00; F26B 25/06

(52) U.S. Cl. CPC F26B 5/06; F26B 25/003; F26B 25/06

(57) ABSTRACT

A lyophilizer includes a shelf and a container, at least one of the shelf and the container including a material having an emissivity greater than or equal to about 0.6 to less than or equal to about 1.0. A shelf plate includes a plate body and a material layer disposed on or defining one or more surfaces of the plate body, the material layer having an emissivity greater than or equal to about 0.6 to less than or equal to about 1.0.

### CROSS-REFERENCE TO RELATED APPLICATIONS

This application claims the benefit of U.S. Provisional Application No. 63/431,134 filed on Dec. 8, 2022. The entire disclosure of the above application is incorporated herein by reference.

### GOVERNMENT FUNDING

This invention was made with government support under contract number H92222-16-C-0081 awarded by the United States Department of Defense. The government may have certain rights in this invention.

### FIELD

The present disclosure relates lyophilizers, and more specifically, to plates, materials, and components for use in and defining the lyophilizers, where one or more of the plates, materials, and components has a high emissivity.

### BACKGROUND

This section provides background information related to the present disclosure which is not necessarily prior art.

Lyophilization (also referred to as freeze drying) includes processes used to preserve materials (including, for example, biological materials and/or foods and/or pharmaceuticals) to increase shelf life of the materials and also to improve transport and safe handling of the materials. Lyophilization commonly occurs by freezing the materials (the material is commonly a liquid at room temperature and pressure) to form solid materials and subjecting the solid materials to a low-pressure and low-temperature environment that is sufficient to take the solid material below its triple point. In the instance of water, for example, the triple point is the temperature (about 0.01° C.) and pressure (about 0.00603 atm) at which all three phases (i.e., vapor, liquid, and ice) of water can exist in equilibrium. Lyophilization is carried out below the triple point to enable conversion of ice into vapor without entering the liquid phase. This conversion from ice to vapor is known as sublimation.

Lyophilization of a solution often occurs using a lyophilizer that includes a shelf system (e.g., a hydraulic shelf system) configured to receive containers loaded with the solution. Lyophilization of the solution in the containers can be accelerated if the solution is frozen into relatively thin solid layers (e.g., ice) having, for example, average thicknesses greater than or equal to about 0.2 centimeters (cm) to less than or equal to about 2.5 centimeters (cm). For example, using thin ice layers for lyophilization can reduce the distance a sublimation front (i.e., the boundary between dry region regions of the layers (which may be referred to as cake) and still frozen regions of the layers (which may be referred to as ice)) needs to move to complete the drying and can also reduce vapor flow resistance of a dry cake layer remaining after the sublimation front passes. During lyophilization, however, not all regions of a thin ice layer dry at the same rate. For example, as the sublimating surface (defined by a length and width of the thin solid layer) is examined during the lyophilization process, some regions may have complete drying to full depth (i.e., thickness) while other regions may still contain the solid (e.g., ice) near a lyophilizer plate (or shelf). The non-uniformed drying may be due, in part, to the non-homogeneous nature of the thin and solid, ice layer. For example, some regions of the thin ice layer may include more amorphous structures as compared to other regions of the thin solid layer and/or may include larger ice crystals.

The non-uniform drying of various regions of cakes can result in non-uniform shrinkage of the cake. This non-uniform cake shrinkage often results in buckling of the intermediate cake (which may still include non-dried structures) relative to the lyophilizer plate. The buckling of the intermediate cake is problematic because regions of the intermediate cake no longer in contact with the lyophilizer plate are unable to efficiently receive conducted heat from the lyophilizer plate, thus slowing drying of these regions and extending the overall drying cycle. Similar concerns regarding conduction heating can be present in areas of the container not in contact with the lyophilizer plate, such as near edges of the container (especially in the instance of flexible containers), and/or in the presence of voids or pores in the intermediate cake. Accordingly, it would be desirable to develop improved materials and processes for freeze drying/lyophilizing solutions.

### SUMMARY

This section provides a general summary of the disclosure and is not a comprehensive disclosure of its full scope or all of its features.

In various aspects, the present disclosure provides a lyophilizer.

In at least one example embodiment, the lyophilizer includes a shelf and a container, at least one of the shelf and the container including a material having an emissivity greater than or equal to about 0.6 to less than or equal to about 1.0.

In at least one example embodiment, the shelf includes a plate body including the material.

In at least one example embodiment, the shelf includes a plate body and a coating disposed on one or more surface of the plate body, the coating including the material.

In at least one example embodiment, the emissivity is a first emissivity, and the plate body has a second emissivity that is less than the first emissivity.

In at least one example embodiment, the emissivity is a first emissivity, and the plate body has a second emissivity that is the same as the first emissivity.

In at least one example embodiment, the container includes a flexible structure and a fixture configured to receive and hold the flexible structure, the fixture including the material.

In at least one example embodiment, the material is a first material, the emissivity is a first emissivity, and the shelf includes a plate body including a second material having a second emissivity, the second emissivity being greater than or equal to about 0.6 to less than or equal to about 1.0.

In at least one example embodiment, the material is a first material, the emissivity is a first emissivity, and the shelf includes a plate body and a coating disposed on one or more surface of the plate body, the coating including a second material having a second emissivity, the second emissivity being greater than or equal to about 0.6 to less than or equal to about 1.0.

In at least one example embodiment, the emissivity is greater than or equal to about 0.8 to less than or equal to about 1.0.

In various aspects, the present disclosure provides a shelf plate for a lyophilizer.

In at least one example embodiment, the shelf plate includes a plate body and a material layer disposed on or defining one or more surfaces of the plate body, the material layer having an emissivity greater than or equal to about 0.6 to less than or equal to about 1.0.

In at least one example embodiment, the emissivity is a first emissivity, and the plate body has a second emissivity that is less than the first emissivity.

In at least one example embodiment, the emissivity is a first emissivity, and the plate body has a second emissivity that is the same as the first emissivity.

In at least one example embodiment, the material layer is a continuous layer.

In at least one example embodiment, the material layer is a discontinuous layer.

In at least one example embodiment, the material layer is an anodized layer.

In at least one example embodiment, the material layer includes a fluoropolymer.

In at least one example embodiment, the fluoropolymer includes polytetrafluoroethylene.

In at least one example embodiment, the plate body includes at least one surface having a non-planar configuration.

In at least one example embodiment, the plate body is configured to receive a container, the container including a flexible structure and a fixture configured to receive and hold the flexible structure.

In at least one example embodiment, the emissivity is a first emissivity, and the fixture includes one or more portions having a second emissivity, the second emissivity being emissivity greater than or equal to about 0.6 to less than or equal to about 1.0.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is an illustration of an example lyophilizer including a shelfing structure in accordance with at least one example embodiment of the present disclosure;

FIG. 2 is an illustration of another example lyophilizer including a shelfing structure in accordance with at least one example embodiment of the present disclosure;

FIG. 3 is an illustration of an example shelfing structure in accordance with at least one example embodiment of the present disclosure;

FIG. 4A is an illustration of an example plate structure including high emissivity materials in accordance with at least one example embodiment of the present disclosure;

FIG. 4B is an illustration of an example plate structure including high emissivity coatings in accordance with at least one example embodiment of the present disclosure;

FIG. 5A is an illustration of another example plate structure including high emissivity coatings in accordance with at least one example embodiment of the present disclosure; and

FIG. 5B is an illustration of an example plate structure including high emissivity coatings in accordance with at least one example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Various components are referred to herein as “operably associated.” As used herein, “operably associated” refers to components that are linked together in operable fashion and encompasses embodiments in which components are linked directly, as well as embodiments in which additional components are placed between the linked components. “Operably associated” components can be “fluidly associated.” “Fluidly associated” refers to components that are linked together such that fluid can be transported between them. “Fluidly associated” encompasses embodiments in which additional components are disposed between the two fluidly associated components, as well as components that are directly connected. Fluidly associated components can include components that do not contact fluid but contact other components to manipulate the system (e.g., a peristaltic pump that pumps fluids through flexible tubing by compressing the exterior of the tube).

Example embodiments will now be described more fully with reference to the accompanying drawings.

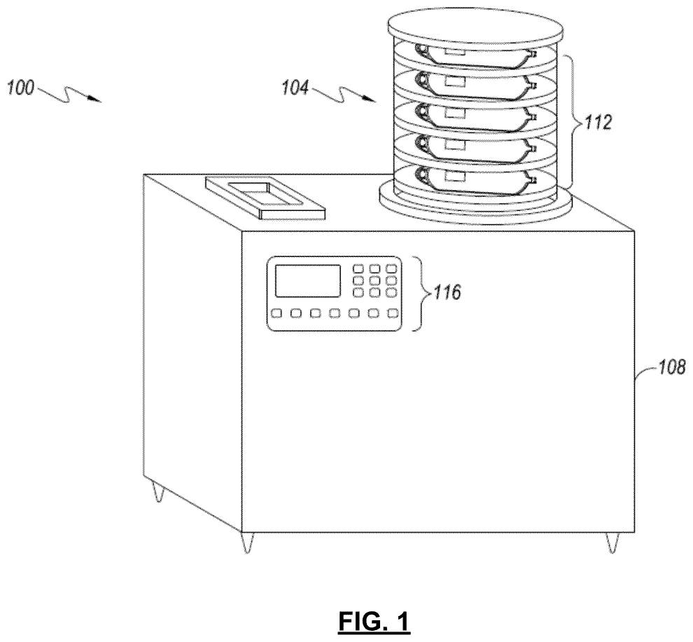

FIG. 1 illustrates an example apparatus 100 for lyophilizing materials, including, for example, biological materials and/or foods and/or pharmaceuticals in the form of liquids, solids, or combinations thereof, to increase shelf life of the materials and also to improve transport and safe handling of the materials. As illustrated, the apparatus 100 includes a chamber 104 encompassing a shelfing structure (which may also be referred to as a shelfing system) 112 configured to hold the materials to be lyophilized and a housing 108 in communication with the chamber and including a user interface 116.

The housing 108 may include a vacuum system (not shown) configured to create a low-pressure environment in the chamber 104, a temperature control system (not shown) configured to control the temperature of the shelfing structure 112, a vapor condensing system (not shown) configured to collect and hold sublimating vapor leaving the chamber 104, and also a control system (not shown) including, for example, a computer system having one or more processors for controlling various functions of the apparatus. The user interface 116 may be configured to allow an operator to input data, parameters, and other information to control certain functions of the apparatus 100. For example, the user interface 116 may permit the operator to communicate with the control system to create and execute custom processes for lyophilizing different materials, including multi-step programmable cycles.

The material to be lyophilized may be placed onto the different shelves of the shelfing structure 112. The temperature control system disposed in the housing 108 and configured to alter the temperature of the shelfing structure 112 may then be used to first freeze the material to be lyophilized and then to further reduce the temperature of the frozen material to a predetermined level which may be, for example, the temperature to be maintained during the sublimation phase of the lyophilization cycle. For example, in the instance of water sublimation, the temperature may be selected to be below the triple point so as to help preserve materials suspended or dissolved in the aqueous solution. For example, in at least one example embodiment, the predetermined level may include temperatures greater than or equal to about −30° C. to less than or equal to about −20° C.

After the material to be lyophilized is frozen and is further cooled to the predetermined temperature, the vacuum system disposed in the housing 108 and configured to alter the pressure within the chamber 104 may be used to bring the environment in the chamber 104 to a pressure that is lower than atmospheric pressure. For example, in at least one example embodiment, the pressure might be lowered to and maintained below an absolute pressure of less than about 100 milli-Torr for a duration of a sublimation period. The sublimation phase or period includes the time lapse between the start of sublimation and the end of sublimation. Sublimation begins as the pressure and temperature in chamber 104 create a chamber environment that is lower than the triple point. Sublimation ends when all ice has been removed from the material to be lyophilized. The sublimation period may vary depending on the material to be lyophilized, quantity of the material to be lyophilized, and the shape, for example, the thickness, of the material to be lyophilized.

In at least one example embodiment, the vacuum system may work in cooperation with the vapor condenser system to maintain an environment within the chamber 104 at a pressure that is the lower than atmospheric pressure. As sublimation takes place at the low chamber pressure, the escaping vapor can carry heat energy away from the material to be lyophilized. The escaping vapor may then be captured onto the vapor condenser system contained within housing 108. The continuous capture of sublimating vapors by the vapor condenser system can help to maintain the low chamber pressure within the sublimating chamber 104. The control system contained within housing 108 may be programmed to control temperature of the shelving structure 112 such that the escaping heat energy is replaced, and the shelving structure is maintained at a temperature sufficient to sustain sublimation until all volatile substances have been removed from the material to be lyophilized. Following sublimation of essentially all volatile material components and/or other material component(s) (i.e., end of the sublimation period), an increased shelf temperature may be set and maintained for an additional period of time to desorb one or more other material components from the material to be lyophilized. The one or more other material may have been previously adsorbed or absorbed by the material. Once desorption is complete, pressure within the chamber may be returned to atmospheric pressure and the now completely dried product may be harvested.

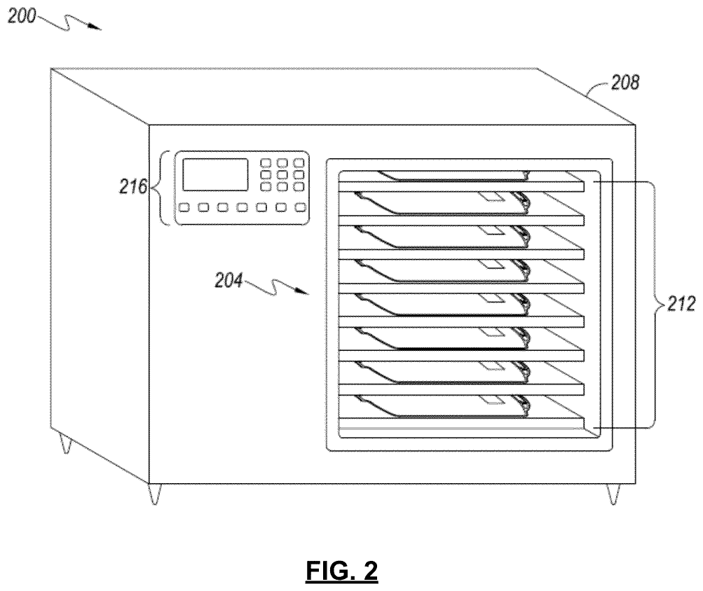

FIG. 2 illustrates another example apparatus 200 for lyophilizing materials including, for example, biological materials and/or foods and/or pharmaceuticals in the form of liquids, solids, or combinations thereof to increase shelf life of the materials and also to improve transport and safe handling of the materials. The apparatus 200 is similar to the apparatus 100, however, in the instance of apparatus 200 the chamber 204 may be disposed within the housing 208. Like the chamber 104, the chamber 204 may be configured to include a shelfing structure (or system) 212 configured to hold the materials to be lyophilized. Also, like the housing 108, the housing 208 may include a user interface 216 configured to allow an operator to input data, parameters, and other information to control certain functions of the apparatus 200.

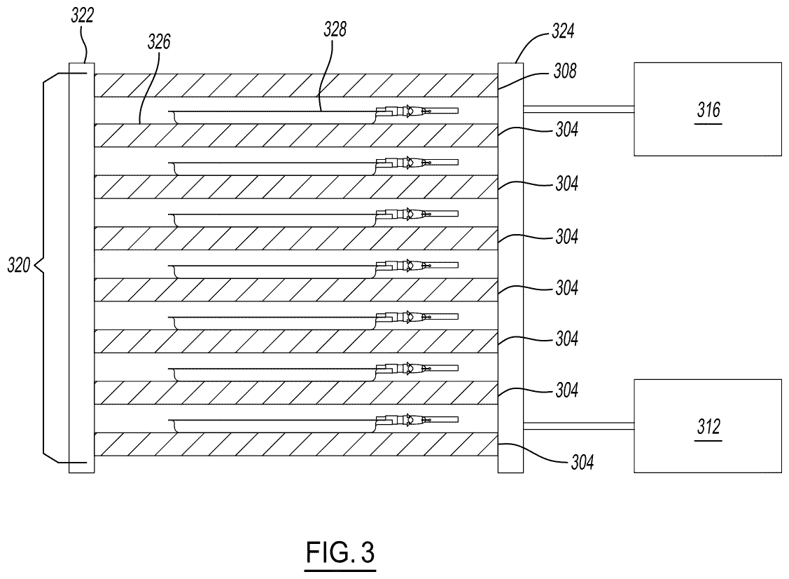

FIG. 3 illustrates an example shelfing structure 320 that may be used for various lyophilization processes, including as shelfing structures 112 and 212 for the lyophilizers 100, 200 illustrated in FIGS. 1 and 2, respectively. The shelfing structure 320 includes a plurality of plates 304 extending between and movable along a pair of side rails 322, 324. Each plate 304 defines a surface 326 for placing a material to be lyophilized. In certain variations, depending on the type of material to be lyophilized, the material may be maintained within a container 328 (such as a fixture, tray, bag, or bottle) and the container 328 placed on the plate 304, as illustrated. The containers 328 may be like those described in U.S. Pat. No. 11,747,082 titled MULTI-PART LYOPHILIZATION CONTAINER AND METHOD OF USE, issued Sep. 5, 2023, and listing Kestas P. Parakininkas, Eric T. Hansen, Kirk L. Weimer, Nathaniel T. Johnson, and Dennis J. Hlavinka as co-inventors and/or U.S. Pat. No. 11,609,042 titled MULTI-PART LYOPHILIZATION CONTAINER AND METHODS OF USE, issued Mar. 21, 2023, and listing Kestas P. Parakininkas, Eric T. Hansen, Kirk L. Weimer, Nathaniel T. Johnson, and Dennis J. Hlavinka as co-inventors and/or U.S. Pat. No. 10,793,327 titled LYOPHILIZATION CONTAINER AND METHOD OF USING THE SAME, issued on Oct. 6, 2022, and listing Kirk L. Weimer, Nate T. Johnson, Dennis J. Hlavinka, and Kestas P. Parakininkas as co-inventors and/or U.S. Pat. No. 11,634,257 titled LYOPHILIZATION CONTAINER AND METHOD OF USING SAME, issued Apr. 25, 2023 and listing Kirk L. Weimer, Nate T. Johnson, Dennis J. Hlavinka, and Kestas P. Parakininkas as co-inventors, the entire disclosures of which are hereby incorporated by reference.

For example, in at least one example embodiment, the containers 328 may be generally flexible containers, including bags and/or trays, which do not evenly contact the plates 304, 308. In other example embodiments, the containers 328 may include fixtures configured to receive a bag or another generally flexible structure that carries or holds the material to be lyophilized. In such instances, the fixtured may be sized to receive, contain, and confine the bag or other flexible structure throughout the lyophilization process. In at least one example embodiment, the fixture may include one or more sealing structures configured to retain the bag or other flexible structure within the fixture. In at least one example embodiment, the fixture may be configured to receive an empty bag or other flexible structure and once positioned the material to be lyophilized may be added to the bag or other flexible structure. Gas, including, for example, air or carbon dioxide, may then be introduced into the bag or other flexible structure to ensure that the bag or other flexible structure conforms to the dimensions of the fixture. The assembly (including the fixture and the bag or other flexible structure including the material to be lyophilized, and optionally a gas) may undergo a lyophilization cycle as detailed above. In at least one example embodiment, the one or more sealing structures may be adjusted during the lyophilization cycle to allow for vapor escape.

With renewed reference to FIG. 3, in at least one example embodiment, the shelfing structure 320 may also include an end plate 308 parallel with the plates 304 and also extending between the pair of rails 322, 324. The end plate 308 may be a stationary plate. The shelfing structure 320 may include a movement control system 312 that is configured to vary the distance between the plates 304. For example, the distance between the plates 304 may be varied to interact with the containers 328 during the lyophilization process. In at least one example embodiment, interaction with the containers 328 may include, for example, closing the container 328 upon completion of the lyophilization process. The movement control system 312 may include a variety of components that work together to move the plates 304. For example, in at least one example embodiment, the movement control system 312 may include a computer system or systems that include memory, input devise, output device, communication devices and/or subsystems such as hydraulic, pneumatic, or mechanical systems that may include one or more motors, actuators, pumps, compressors, cylinders, pistons, tubing, valves, bladders, sensors, and/or regulators. The movement control system 312 may be removably coupled to the plates 304 using any appropriate connections, including, for example, connectors, tubings, fittings, pipes, and/or adapters.

The shelfing structure 320 may also include a thermal fluid system 316 that is configured to circulate a thermal fluid through and/or around at least a portion of the plurality of plates 304. For example, in at least one example embodiment, the thermal fluid system 316 may be removably coupled to the plates 304 using any appropriate connections, including, for example, connectors, tubings, fittings, pipes, and/or adapters. In each instance, the movement of the thermal fluid may be used to remove and/or add energy to at least a portion of the plurality of plates 304. For example, the movement of the thermal fluid may be used to control the temperature of one or more of the plurality of plates and the materials for lyophilization disposed on the plates.

In each variation, one or more of the plurality of plates 304 and/or the end plate 308 and/or the container 328 (particularly, in the instance where the container 328 includes a fixture) may be include (e.g., formed of), or (at least partially) coated with, a high emissivity material (e.g., materials having emissivities greater than about 0.9), for example, to help maintain the temperature of the plurality of plates 304 and/or the end plate 308 and/or the container 328 at temperature above the ice temperature.

All materials emit thermal radiation at temperatures above absolute zero. For example, the emissivity of a material is the relative ability of its surface to emit heat by radiation. Emissivity can be defined as the ratio of the energy radiated from an object's surface to the energy radiated from an ideal radiator (e.g., a black body) at the same temperature. Emissivity values are dimensionless numbers and values range from 0 to 1, where a blackbody (e.g., a perfect radiator) has an emissivity of 1, and a perfect reflector has an emissivity of 0. The incorporation of high emissivity materials in the instance of lyophilization applications may augment radiated heat transfer allowing materials (e.g., intermediate cake) not in contact with the lyophilizer plates (for example, as the result of cake buckling and/or elevated container edge geometry, especially in the instance of flexible containers) to be more readily heated.

In at least one example embodiment, one or more of the plurality of plates 304 and/or the end plate 308 and/or the container 328 (particularly, in the instance where the container 328 includes a fixture) may include (e.g., be formed of) a high emissivity material. For example, the one or more of the plurality of plates 304 and/or the end plate 308 and/or the container 328 (particularly, in the instance where the container 328 includes a fixture) may include a material having an emissivity greater than or equal to about 0.6, optionally greater than or equal to about 0.8, and in certain aspects, optionally greater than or equal to about 0.9.

In at least one example embodiment, one or more of the plurality of plates 304 and/or the end plate 308 and/or the container 328 (particularly, in the instance where the container 328 includes a fixture) may include (e.g., be formed of) metallic materials, including, for example, aluminum, stainless steel, steel, iron, copper, titanium, brass, nickel, or any combination thereof. In at least one example embodiment, one or more of the plurality of plates 304 and/or the end plate 308 and/or the container 328 (particularly, in the instance where the container 328 includes a fixture) may include (e.g., be formed of) aluminum with polished surfaces having emissivities greater than or equal to about 0.04 to less than or equal to about 0.06 and/or stainless steel with polished surfaces having emissivities of about 0.075. In at least one example embodiment, polished stainless steel may be preferred because of its corrosion resistance and also its ability to withstand aggressive cleaning agents that are especially desirable for food or medical applications.

In at least one example embodiment, one or more of the plurality of plates 304 and/or the end plate 308 and/or the container 328 (particularly, in the instance where the container 328 includes a fixture) may include (e.g., be formed of) a first material having a first emissivity and (at least partially) coated with a second material having a second emissivity that is greater than the first emissivity. The second material defining the coating may have an emissivity greater than or equal to about 0.6, optionally greater than or equal to about 0.8, and in certain aspects, optionally greater than or equal to about 0.9. In at least one example embodiment, the first material may include a metallic material and the second material may include various oil paints having emissivities greater than or equal to about 0.6, optionally greater than or equal to about 0.8, and in certain aspects, optionally greater than or equal to about 0.9. In at least one example embodiment, the first material may include, for example, polished aluminum having an emissivity greater than or equal to about 0.04 to less than or equal to about 0.06 and/or polished stainless steel having an emissivity of about 0.075. In at least one example embodiment, the second material may include for example, 3M black velvet coating 9560 series optical black paints. In at least one example embodiment, the second material may include a fluoropolymer, such as polytetrafluoroethylene having an emissivity greater than about 0.9. In still other example embodiments, for example in the case of aluminum as the first material, the second material may include an anodized layer created using an electrochemical surface treatment process. In each instance, the coating may have a thickness sufficient to increase the emissivity to greater than about 0.9. The one or more of the plurality of plates 304 and/or the end plate 308 and/or the container 328 (particularly, in the instance where the container 328 includes a fixture) including the high emissivity coatings may have emissivities greater than or equal to about 0.9 to less than or equal to about 1.

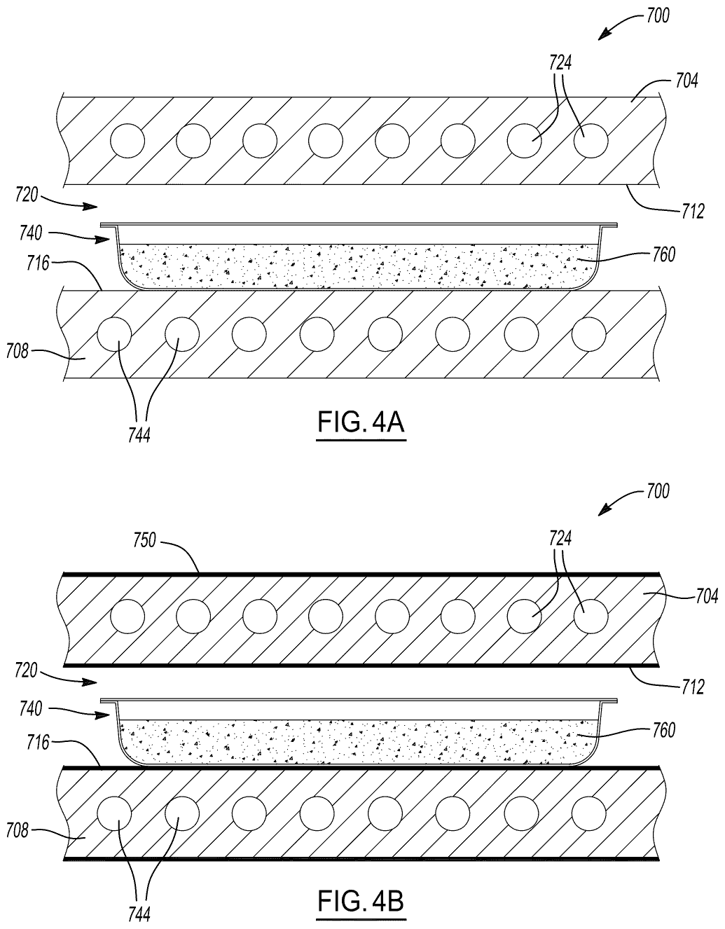

FIGS. 4A and 4B illustrate an example plate structure 700 that may be used for various lyophilization processes, including as plates 304, 308, for the shelfing structure 320 illustrated in FIG. 3. The example plate structure 700 illustrates two example plates: a first plate 704 and a second plate 708. The first plate 704 includes a surface 712 that opposes to a surface 716 of the second plate 708. A space 720 is defined between the surface 712 of the first plate and the surface 716 of the second plate 708. A container 740 configured to carry (or hold) a material 760 to be lyophilized disposed within the space 720. In at least one example embodiment, the container 740 may include a flexible container that does not evenly contact the plate 708. In another example embodiment, the container 740 may include a fixture configured to receive a bag or another flexible structure that carries or holds the material to be lyophilized. The first plate 704 and the second plate 708 may have a similar structure. For example, in at least one example embodiment, as illustrated, the plate 704 may have a plurality of channels 724 configured to provide flow paths for a thermal fluid that can be used to control the temperature of the first plate 704. Similarly, the second plate 708 may include a plurality of channels 744 configured to provide flow paths for a thermal fluid that can be used to control the temperature of the second plate 708.

In each instance, the first plate 704 and/or the second plate 708 and/or the container 740 (particularly, in the instance where the container 740 includes a fixture) may include (e.g., be formed of), or (at least partially) coated with, a high emissivity material (e.g., materials having emissivities greater than about 0.9).

In at least one example embodiment, for example, as illustrated in FIG. 4A, the first plate 704 and/or the second plate 708 may include (e.g., be formed of) a high emissivity material. For example, the first plate 704 and/or the second plate 708 may include a material having an emissivity greater than or equal to about 0.6, optionally greater than or equal to about 0.8, and in certain aspects, optionally greater than or equal to about 0.9.

In other example embodiments, for example, as illustrated in FIG. 4B, the first plates 704 and/or the second plate 708 may include (e.g., be formed of) a first material having a first emissivity and (at least partially) coated with a second material having a second emissivity that is greater than the first emissivity. The second emissivity may be greater than or equal to about 0.6, optionally greater than or equal to about 0.8, and in certain aspects, optionally greater than or equal to about 0.9. The second material may coat one or more surfaces of the first plate 704 and/or the second plate 708 defining one or more high emissivity coatings 750. The high emissivity coatings 750 may be discontinuous coatings or substantially continuous coatings including one or more layers and covering, for example, greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal or equal to about 99%, and in certain aspects, optionally greater than or equal to about 99.5% of a total surface area of the one or more surfaces of the first plates 704 and/or the second plate 708. In other example embodiments, the high emissivity coatings may be continuous coatings covering, for example, greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal or equal to about 99%, and in certain aspects, optionally greater than or equal to about 99.5% of a total surface area of a portion of the plate 704, 708 to be aligned with (e.g., contacted) the container (such as a tray, bag, or bottle) including the material to be to be lyophilized. In each instance, the coatings 750 should have sufficient continuity and thicknesses to increase the shelf surface emissivity to greater than about 0.9. The one or more of the first plates 704 and/or the second plate 708 including (e.g., formed from) the high emissivity material may have emissivities greater than or equal to about 0.9 to less than or equal to about 1.

In at least one example embodiment, the first material may include a metallic material and the second material may include various oil paints having emissivities greater than or equal to about 0.6, optionally greater than or equal to about 0.8, and in certain aspects, optionally greater than or equal to about 0.9. In at least one example embodiment, the first material may include, for example, polished aluminum having an emissivity greater than or equal to about 0.04 to less than or equal to about 0.06 and/or polished stainless steel having an emissivity of about 0.075. In at least one example embodiment, the second material may include for example, 3M black velvet coating 9560 series optical black paints. In at least one example embodiment, the second material may include a fluoropolymer, such as polytetrafluoroethylene having an emissivity greater than about 0.9. In still other example embodiments, for example in the case of aluminum as the first material, the second material may include an anodized layer created using an electrochemical surface treatment process. In each instance, the coating may have a thickness sufficient to increase the emissivity to greater than about 0.9. The one or more of the first plates 704 and/or the second plate 708 including the high emissivity coatings may have emissivities greater than or equal to about 0.9 to less than or equal to about 1.

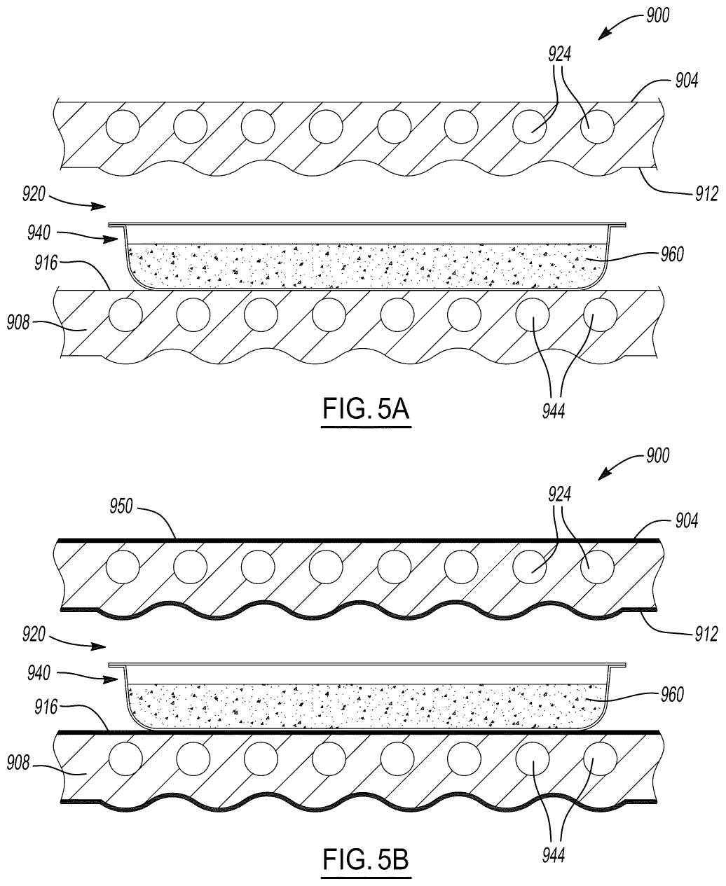

FIGS. 5A and 5B illustrate another example plate structure 900 that may be used for various lyophilization processes, including as plates 304, 308, for the shelfing structure 320 illustrated in FIG. 3. The example plate structure 900 illustrates two example plates: a first plate 904 and a second plate 908. The first plate 904 includes a first surface 912 that opposes to a second surface 916 of the second plate 908. A space 920 is defined between the surface 912 of the first plate and the surface 916 of the second plate 908. A container 940 configured to carry (or hold) a material 960 to be lyophilized disposed within the space 920. In at least one example embodiment, the container 940 may be a flexible container that does not evenly contact the plate 908. In another example embodiment, the container 940 may include a fixture configured to receive a bag or another flexible structure that carries or holds the material to be lyophilized.

In at least one example embodiment, for example, as illustrated, plate surfaces away from the containers 940 like the first surface 912 of the first plate 904 may be shaped to increase overall surface area and thereby radiation from the first surface 912. For example, as illustrated, plate surfaces away from the containers 940 like the first surface 912 of the first plate 904 may have a non-planar (e.g., wavy) configuration. Although it should be recognized that in other variations alternative topographies may be chosen to also increase and thereby improve radiating surface area. The first plate 904 and the second plate 908 may have a similar structure. For example, in at least one example embodiment, as illustrated, the plate 904 may have a plurality of channels 924 configured to provide flow paths for a thermal fluid that can be used to control the temperature of the first plate 904. Similarly, the second plate 908 may include a plurality of channels 944 configured to provide flow paths for a thermal fluid that can be used to control the temperature of the second plate 908.

In each instance, the first plate 904 and/or the second plate 908 and/or the container 940 (particularly, in the instance where the container 940 includes a fixture) may include (e.g., be formed of), or (at least partially) coated with, a high emissivity material (e.g., materials having emissivities greater than about 0.9).

In at least one example embodiment, for example, as illustrated in FIG. 5A, the first plate 904 and/or the second plate 908 may (e.g., be formed of) a high emissivity material. For example, the first plate 704 and/or the second plate 708 may include a material having an emissivity greater than or equal to about 0.6, optionally greater than or equal to about 0.8, and in certain aspects, optionally greater than or equal to about 0.9. The one or more of the first plates 904 and/or the second plate 908 including (e.g., formed from) the high emissivity material may have emissivities greater than or equal to about 0.9 to less than or equal to about 1.

In other example embodiments, for example, as illustrated in FIG. 5B, the first plate 904 and/or the second plate 908 may include (e.g., be formed of) a first material having a first emissivity and (at least partially) coated with a second material having a second emissivity that is greater than the first emissivity. The second emissivity may be greater than or equal to about 0.6, optionally greater than or equal to about 0.8, and in certain aspects, optionally greater than or equal to about 0.9. The second material may coat one or more surfaces of the first plate 904 and/or the second plate 908 defining one or more high emissivity coatings 950. The high emissivity coatings 950 may be discontinuous coatings or substantially continuous coatings including one or more layers and covering, for example, greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal or equal to about 99%, and in certain aspects, optionally greater than or equal to about 99.5% of a total surface area of the one or more surfaces of the first plates 704 and/or the second plate 708. In other example embodiments, the high emissivity coatings 950 may be continuous coatings covering, for example, greater than or equal to about 75%, optionally greater than or equal to about 80%, optionally greater than or equal to about 85%, optionally greater than or equal to about 90%, optionally greater than or equal to about 95%, optionally greater than or equal to about 98%, optionally greater than or equal or equal to about 99%, and in certain aspects, optionally greater than or equal to about 99.5% of a total surface area of a portion of the plate 904, 908 to be aligned with (e.g., contacted) with the container (such as a tray, bag, or bottle) including the material to be to be lyophilized. In each instance, the high emissivity coatings 950 should have sufficient continuity and thicknesses to increase the shelf surface emissivity to greater than about 0.9.

In at least one example embodiment, the first material may include a metallic material and the second material may include various oil paints having emissivities greater than or equal to about 0.6, optionally greater than or equal to about 0.8, and in certain aspects, optionally greater than or equal to about 0.9. In at least one example embodiment, the first material may include, for example, polished aluminum having an emissivity greater than or equal to about 0.04 to less than or equal to about 0.06 and/or polished stainless steel having an emissivity of about 0.075. In at least one example embodiment, the second material may include for example, 3M black velvet coating 9560 series optical black paints. In at least one example embodiment, the second material may include a fluoropolymer, such as polytetrafluoroethylene having an emissivity greater than about 0.9. In still other example embodiments, for example in the case of aluminum as the first material, the second material may include an anodized layer created using an electrochemical surface treatment process. In each instance, the coating may have a thickness sufficient to increase the emissivity to greater than about 0.9. The one or more of the first plate 904 and/or the second plate 908 including the high emissivity coatings may have emissivities greater than or equal to about 0.9 to less than or equal to about 1.

Although not specifically illustrated, it should be recognized that in various aspects the lyophilizers 100, 200 and/or the shelfing structure 320 and/or the plate structures 700, 900 may include a variety to other components. For example, in at least one example embodiment, the lyophilizers 100, 200 and/or the shelfing structure 320 and/or the plate structures 700, 900 may include different plate structures and/or compositions and/or a mechanisms for moving the plates as described in U.S. Pat. No. 10,969,171, titled LYOPHILIZATION, issued Apr. 6, 2021 and listing Frank Corbin, III, Dennis J. Hlavinka, Rajesh Pareta, and Mark E. Hillam as co-inventors, and/or U.S. Pat. No. 11,067,336, titled LYOPHILIZATION, issued Jul. 20, 2021 and listing Frank Corbin, III, Dennis J. Hlavinka, Rajesh Pareta, and Mark E. Hillam as co-inventors, the entire disclosures of which are hereby incorporated by reference.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lyophilizer comprising:
a shelf; and
a container, at least one of the shelf and the container including a material having an emissivity greater than or equal to about 0.6 to less than or equal to about 1.0.

2. The lyophilizer of claim 1, wherein the shelf includes:
a plate body including the material.

3. The lyophilizer of claim 1, wherein the shelf includes:
a plate body; and
a coating disposed on one or more surface of the plate body, the coating including the material.

4. The lyophilizer of claim 3, wherein the emissivity is a first emissivity, and the plate body has a second emissivity that is less than the first emissivity.

5. The lyophilizer of claim 3, wherein the emissivity is a first emissivity, and the plate body has a second emissivity that is the same as the first emissivity.

6. The lyophilizer of claim 1, wherein the container includes:
a flexible structure; and
a fixture configured to receive and hold the flexible structure, the fixture including the material.

7. The lyophilizer of claim 6, wherein the material is a first material, the emissivity is a first emissivity, and the shelf includes:
a plate body including a second material having a second emissivity, the second emissivity being greater than or equal to about 0.6 to less than or equal to about 1.0.

8. The lyophilizer of claim 6, wherein the material is a first material, the emissivity is a first emissivity, and the shelf includes:
a plate body; and
a coating disposed on one or more surface of the plate body, the coating including a second material having a second emissivity, the second emissivity being greater than or equal to about 0.6 to less than or equal to about 1.0.

9. The lyophilizer of claim 1, wherein the emissivity is greater than or equal to about 0.8 to less than or equal to about 1.0.

10. A shelf plate for a lyophilizer, the shelf plate comprising:
a plate body; and
a material layer disposed on or defining one or more surfaces of the plate body, the material layer having an emissivity greater than or equal to about 0.6 to less than or equal to about 1.0.

11. The shelf plate of claim 10, wherein the emissivity is a first emissivity, and the plate body has a second emissivity that is less than the first emissivity.

12. The shelf plate of claim 10, wherein the emissivity is a first emissivity, and the plate body has a second emissivity that is the same as the first emissivity.

13. The shelf plate of claim 10, wherein the material layer is a continuous layer.

14. The shelf plate of claim 10, wherein the material layer is a discontinuous layer.

15. The shelf plate of claim 10, wherein the material layer is an anodized layer.

16. The shelf plate of claim 10, wherein the material layer comprises a fluoropolymer.

17. The shelf plate of claim 16, wherein the fluoropolymer comprises polytetrafluoroethylene.

18. The shelf plate of claim 10, wherein the plate body comprises at least one surface having a non-planar configuration.

19. The shelf plate of claim 10, wherein the plate body is configured to receive a container, the container including:
a flexible structure; and
a fixture configured to receive and hold the flexible structure.

20. The shelf plate of claim 19, wherein the emissivity is a first emissivity, and the fixture includes one or more portions having a second emissivity, the second emissivity being emissivity greater than or equal to about 0.6 to less than or equal to about 1.0.
